(19) United States
(12) Patent Application Publication
(10) Pub. No.: US 2002/0073031 A1
(43) Pub. Date: Jun. 13, 2002

(54) Collective balance calculation automatic process system

(75) Inventor: Mikiya Nakazima, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/068,844

(22) Filed: Feb. 11, 2002

Related U.S. Application Data
(63) Continuation of application No. PCT/JP99/04437, filed on Aug. 18, 1999.

(51) Int. Cl. G06F 17/60

(52) U.S. Cl. 705/42

(57) ABSTRACT

The medium data read out section reads out the bank code and account number from the medium, the read out bank code being recorded in the first memory, and the read out account number being recorded in the second memory, or to be recorded in the second memory if not recorded where the medium is subsequently returned to the customer. Also, the medium read out section performs the same process described above on other mediums inserted by the customer, producing a determination of insertion being completed upon finding no more insertions of other mediums from the customer. The account balance data drawing section draws and collectively calculates the balance corresponding to the read out account number specified by each read out bank code, by referring to the account data accumulation section.

### CROSS-REFERENCE TO RELATED APPLICATIONS

This application is a continuation application and is based upon PCT/JP99/04437, filed on Aug. 18, 1999.

1. Technical Field

This invention relates to a collective balance calculation automatic process system, particularly to a balance automatic process system, which comprises an automatic transaction apparatus (Automated Tellers Machine: ATM) provided at a cash corner in banks for deposit and withdrawal and a host computer, wherein the balance of all a customer's accounts can be checked together according to a customer's request.

2. Technical Background

ATMs are in wide use with a card or a bankbook, customers can make various transactions, including automatic deposit and withdrawal, by manual operation, at a variety of places. ATMs are usually operational outside a bank's normal business hours, and offer a time extension service as a part of a bank's customer services. With such availability, ATMs have been increasing in number and are now available in many places, including department stores and station premises, not to mentioning cash corners. Under these circumstances, an improved service function for ATMs is a focus of attention as an important step for acquiring new customers.

As a service function of ATMs, calculation of the total balance is widely known. For example, an automatic transaction apparatus having total reference function for doing total balance reference is disclosed in the patent bulletin, JPP-6-139431. This apparatus is provided with a balance reference function, by which the transaction balance of a pre-registered account can be checked. The apparatus, having such function, comprises a total reference data input section for inputting the total reference data of a customer having a plurality of accounts, and an output section for outputting the data of customer's plural accounts balance after having collectively drawn and calculated the above mentioned customer's accounts data.

The invention described above, however, requires customer to register the accounts with his or her own bank in advance. Therefore, an inconvenience occurs that total reference of the accounts is limited to only for the pre-registered accounts and non-registered accounts cannot be totally checked.

There is another example, disclosed in the patent bulletin, JPP-1-302468, which is an automatic transaction apparatus capable of displaying the past transaction records, as well as the transaction balance. According to this example, the automatic transaction apparatus having a balance displaying function comprises a management section for managing the transaction information and transaction balance, a display section for displaying the transaction balance which is under management, a reference section for performing reference transaction by which the transaction balance stored in a recording section is identified, and a control section for performing control in a way that past transaction records are displayed with the transaction balance upon identifying the transaction balance. This example, however has, as a purpose, a particular customer service in which a customer's past transaction records is displayed together with the transaction balance.

### DISCLOSURE OF THE INVENTION

The purpose of this invention is to provide a collective balance calculation automatic process system, by which a customer can easily make a total reference to his or her account, without a need of pre-registration of the accounts, wherein the account for total reference includes each account opened at plural banks by one customer, all the accounts opened at a particular bank by one customer, and one or plural accounts which are required by the customer to be collectively calculated. Further, the collective balance calculation automatic process system also enables the customer to easily enter a missing transaction record in any account (entry) if such record is found by the balance reference, and to easily deposit or transfer the money from his or her other account into an particular account where the balance is short (minus balance), if such account is found by the balance reference.

To achieve the purpose of this invention described above, the first embodiment of this invention is disclosed. According to the first embodiment, the collective balance calculation automatic process system is related to an automatic transaction system, comprising the host computer and a plurality of ATMs, by which a customer can automatically deposit or withdraw the money.

The above collective balance calculation automatic process system comprises an account data accumulation section for collectively storing the balance data from each customer account, an account balance data drawing section for drawing the balance in each customer account from the account data accumulation section and collectively calculating it, first storage means for storing one or a plurality of bank codes, second storage means for storing one or a plurality of account numbers, and a medium data read out section for reading out customer data recorded in a customer's medium and transmitting them to said account balance data drawing section.

The medium data read out section reads out the bank code and the account number from the medium, the read out bank code being recorded in the first storage means, the read out account number being recorded in the second storage means, wherein if the read out account number is not recorded, it is to be recorded and the medium is returned to the customer temporarily. The medium data read out section also performs the same process on other mediums inserted by the same customer and determines that the medium insertion is completed, with no insertion of another medium. The account balance data drawing section draws and collectively calculates the balance corresponding to the read out account number specified by each read out bank code, with referring to the account data accumulation section.

According to the second embodiment of this invention, which is also disclosed, the collective balance calculation automatic process system is related to the automatic transaction system, comprising the host computer and a plurality of ATMs, by which customer can automatically deposit or withdraw the money.

The above collective balance calculation automatic process system comprises the account data accumulation section for collectively storing the balance data from each customer account, the account balance data drawing section for drawing the balance in each customer account from the account data accumulation section and collectively calculating them, a storage means for storing one or a plurality of account numbers, and the medium data read out section for reading out the customer data recorded in customer's medium and transmitting them to the account balance data drawing section. The medium data read out section reads out the account number from the medium, the read out account number being recorded in the storage means, wherein if the read out account number is not recorded, it is to be recorded and the medium is returned to the customer temporarily.

The medium data read out section also performs the same process on other mediums inserted by the customer and determines that the medium insertion is completed, with no insertion of another medium. The account balance data drawing section draws and collectively calculates the balance corresponding to the read out account number specified by each read out bank code, by referring to the account data accumulation section.

According to the preferred embodiments, the collective balance calculation automatic process system herein disclosed further comprises third storage means for storing the existence or non-existence of a no-entry and a no-entry detection section for detecting a no-entry balance in each customer's account, wherein the no-entry detection section draws the balance corresponding to the read out account number specified by each read out bank code, and, upon finding of the no-entry balance, sets a flag in the third storage means through which compiling of print data, and printing out are sequentially performed.

Also, according to the preferred embodiments, the collective balance calculation automatic process system herein disclosed further comprises a fourth storage means for storing the existence or non-existence of a minus balance and a minus balance detection section for detecting the existence or non-existence of a minus balance in each customer's account, wherein the minus balance detection section draws the balance corresponding to the read out account number specified by each read out bank code, and, upon finding of the minus balance, sets the flag in the fourth storage means through which compiling of print data and printing out are sequentially performed.

This invention, having the constitution described above, can be achieved by utilizing conventional hardware and by partially replacing the software contained therein, so that cost for system construction can be minimized. Also, this invention enables customers to check his or her desired account balance all together without registering the account in advance. Not only that, the invention guides customers, in the course of the above processes, to manually perform a no-entry process, and deposit or transfer upon finding of the minus balance. These function realized by this invention offers customers significantly convenient services, which can be enjoyed by customers at facility where the invented ATM is installed, leading to an increased number of customer visits. Furthermore, while the invention can processes both the bank card and the bankbook, the invention can also be applied to an automatic cash dispenser (CD). A description is to be presented later in another embodiment in which addition of new memories enables this invention to process other bank's accounts, as well as customers' own bank's account, so that customers have an advantage of a more convenient total balance reference service.

### BRIEF DESCRIPTION OF DRAWINGS

FIG. 1 is a view showing a block construction representing one embodiment of the collective balance calculation automatic process system according to the present invention.

FIG. 2 (A) is a view for explaining the magnetic stripe provided on a customer's magnetic card for an ATM transaction.

FIG. 2 (B) is a view for explaining the magnetic stripe provided on a customer's bankbook for an ATM transaction.

FIG. 3 is a view for explaining one example of the stored contents in the memory 1 to 4 represented in FIG. 1.

FIG. 4 and FIG. 5 are flow charts showing one example of processes performed in the collective balance calculation automatic process system represented in FIG. 1.

FIG. 6 and FIG. 7 are flow charts showing processes performed upon finding of the no-entry balance during the course of processes represented in FIG. 4 and FIG. 5.

FIG. 8 and FIG. 9 are flow charts showing processes performed upon finding of the minus balance in customer's account during the course of processes represented in FIG. 4 and FIG. 5.

FIG. 10 and FIG. 11 are flow charts showing processes on another example, performed in the collective balance calculation automatic process system represented in FIG. 1.

FIG. 12 is a view of a receipt printed out and ejected, for customer, from an ATM in the processes represented in FIG. 4 to FIG. 11.

### PREFERRED EMBODIMENTS FOR PRACTICE

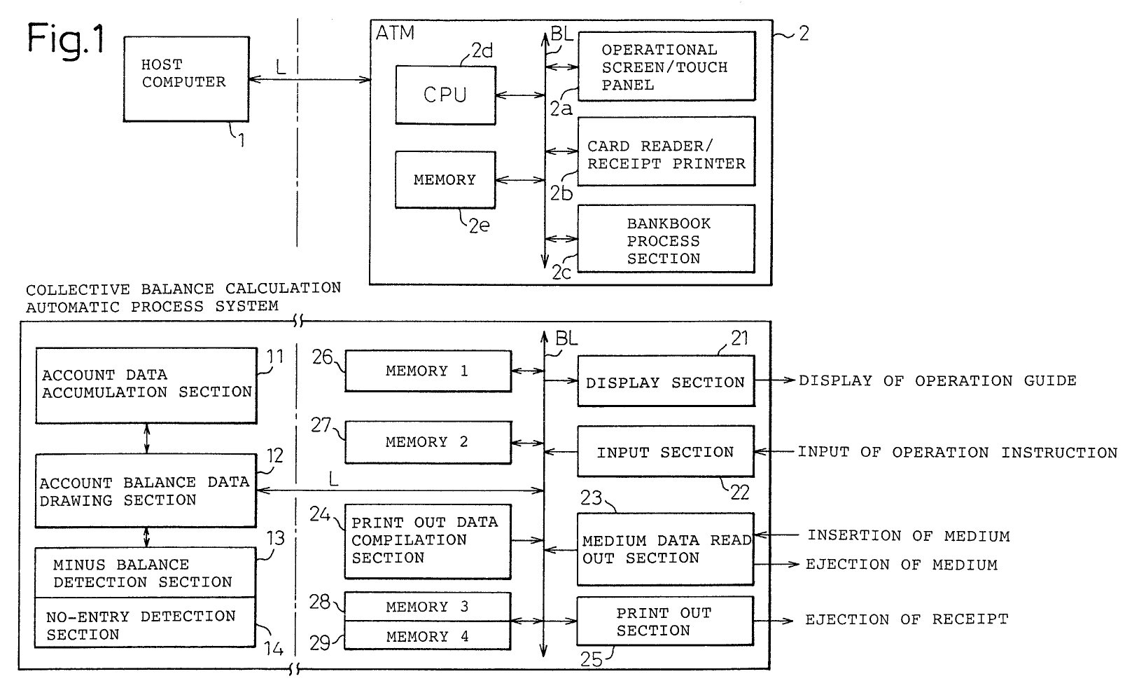

FIG. 1 is a view showing the block constitution representing one embodiment of the collective balance calculation automatic process system herein disclosed. As mentioned before, several ATMs are installed in a variety of places, and each ATM is connected, for example via a communication line L, to a host computer 1. As indicated in this drawing, an ATM basically comprises an operation screen/touch panel 2a for displaying the operational steps of ATMs for customers, a card reader/receipt printer 2b as an input/output device for customers, data, a bankbook process section 2c for processing the contents of the bankbook, a microcomputer (CPU) 2d for controlling operations between the host computer 1 and a ATM 2, and a memory 2e for storing a variety of programs, needed for automatic transaction, and affiliated data.

Also, according to the collective balance calculation automatic process system herein disclosed, the host computer 1 includes an account data accumulation section 11, an account balance data transaction section 12, a minus balance detection section 13, and a no-entry detection section 14. Further, ATM 2 includes a display section 21, an input section 22, a medium data read out section 23, a print out data compilation section 24, print out section 25, and memories 26 to 29. These components are connected each other via a bus line BL and, as described above, the units in the host computer and the units in ATM are connected, for example, via the communication line L.

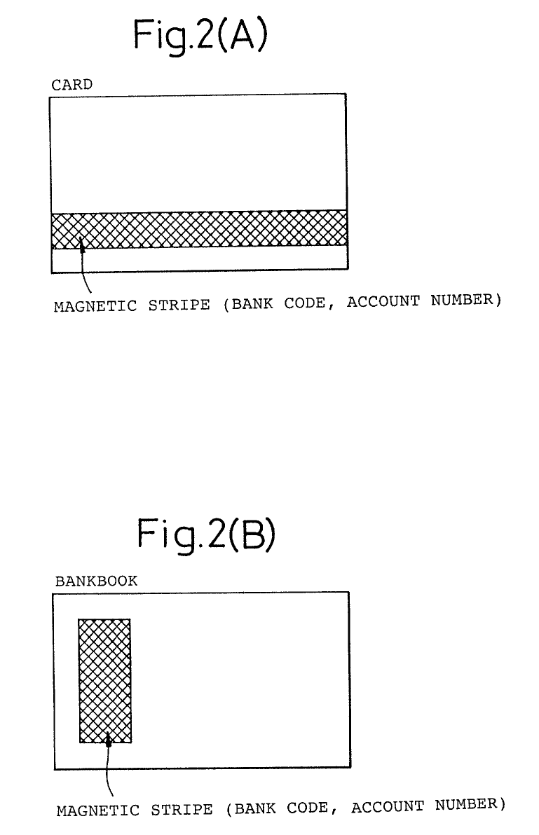

In the constitution described here, the display section 21 displays an operational guidance explaining to customers the operational steps, and the input section 22 is a unit through which an instruction by a customer is entered. Both above sections correspond to the operation screen/touch panel 2a, respectively. The medium data read out section 23 reads out the data (stored data in the magnetic stripes shown in FIG. 2 (A), FIG. 2 (B), or the IC card (no drawing)) on a medium (card or bankbook) inserted by a customer, and ejects the medium after having finished predetermined processes, the section corresponding to the card reader 2b and the bankbook process section 2c. The print data compilation section 24 compiles the collectively calculated balance into a viewable form. The print out section 25 prints out the compiled balance on a receipt and ejects it. The memories 1 to 4 (26 to 29) store bank codes and account numbers and corresponds to the memory 2e.

Also, the account data accumulation section 11 totally stores the data collected from each account. The account balance data drawing section 12 draws the balance from the account data accumulation section 11. The minus balance detection section 13 detects whether the account balance is minus or not. The no-entry detection section 14 detects the existence or non-existence of the entry data for the bankbook.

FIG. 2 (A) is a view for explaining the magnetic stripe provided to customer's magnetic card for ATM operation. FIG. 2 (B) is the view for explaining the magnetic stripe provided to customer's bankbook for AM operation. The magnetic stripes contain data, including customer's bank code and account number. Upon insertion of the media (card or bank book) into the ATM by a customer, the medium data read out section 23 reads out the customer data from the magnetic stripe, and transmits the read out customer data, via the communication line L, to the account balance data drawing section 12 in the host computer 1.

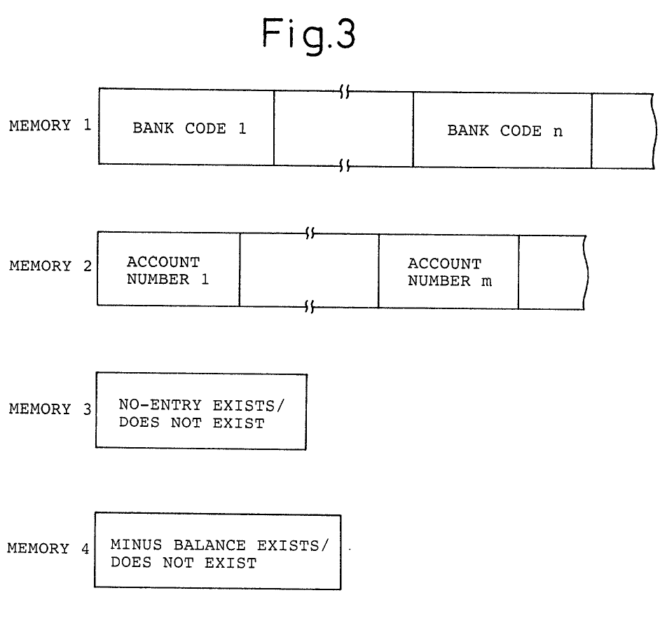

FIG. 3 is a view for explaining the stored contents in memories 1 to 4. The memory 1 (26) stores a plurality of bank codes 1 to n, which are to be processed by the collective balance calculation automatic process system. The memory 2 (27) sequentially stores the account numbers, which are read out by the medium data read out section 23. The memory 3 (28) stores the prescribed displays indicating the existence or non-existence of the no-entry account. The memory 4 (29) stores the prescribed displays indicating the existence or non-existence of the balance-shorted (minus balance) account.

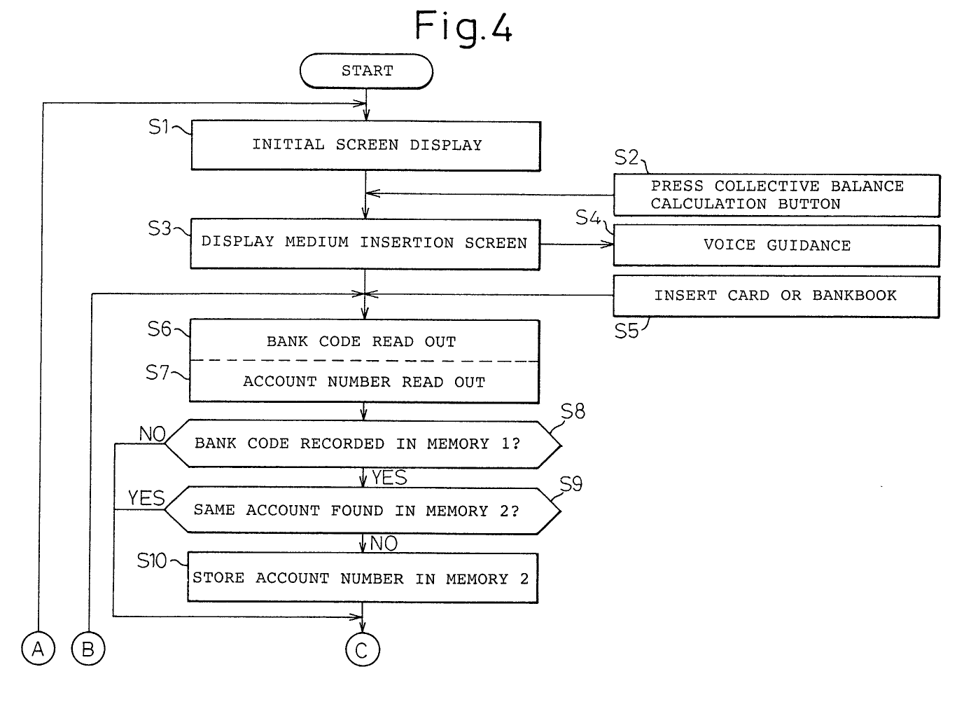

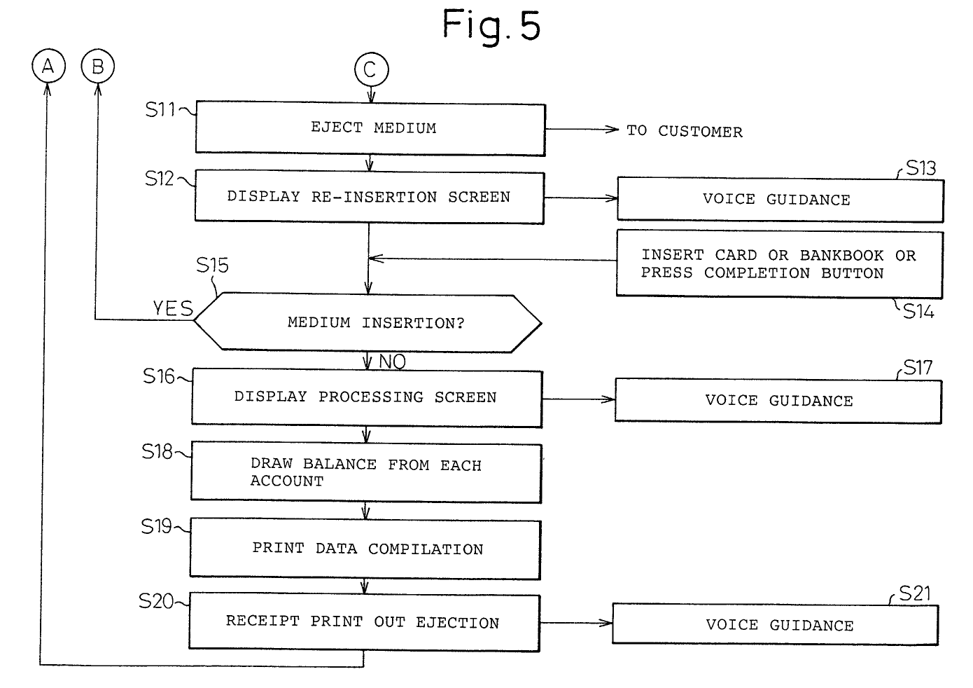

FIG. 4 and FIG. 5 are the flow charts showing one example of the process performed in the collective balance calculation automatic process system. As shown in FIG. 4, first “initial screen” is displayed on ATM's display section (S1). When a customer presses a collective balance calculation display (S2) on the display screen, a “medium insertion screen” is displayed. At the same time, a voice instruction, saying “Please, insert your card or bankbook.”, comes up (S4). The customer, following the voice instruction, inserts the card or bankbook into ATM's input section (S5).

ATM's medium read out section 23 reads out the bank code (S6), and also reads out the account number (S7), from the magnetic stripe on customer's card or bankbook. Next step is a determination on whether the read out bank code is in the memory 1 or not (S8), wherein a finding of the bank code in the memory 1 produces (YES) answer. Then determination on whether the read out account number is in the memory 2 or not follows (S9) wherein not finding the account number in the memory 2 produces (NO) answer. The account number not found is stored in the memory 2 (S10), and the card or the bankbook is temporarily ejected (S11).

Meanwhile, as shown in FIG. 5, the card or bankbook is also temporarily ejected out in the both cases, where the bank code is not found in the memory 1 (NO) at step S8 and the account number is found in the memory 2 (YES) at step S9. Subsequently, a “medium reinsertion screen” is displayed on the screen (S12), which is followed by either a voice instruction, saying “Please, insert your card or bankbook of another account number.” or “Please, press the completed button.” (S13).

According to the voice instruction, the customer either inserts the card or bankbook of another account number, or presses the “completed” button (S14). ATM determines whether other card or bankbook is inserted or not (S15), and no insertion produces (NO) answer, which is followed by displaying of “processing screen” (S16). Then a voice guidance comes up, saying “Calculation is proceeding. Thank you for waiting.” (S17). On the other hand, when other card or bankbook is inserted at S15 (YES), the customer performs steps 6 to S15 once again, and repeats those steps until other cards or bankbooks are all processed.

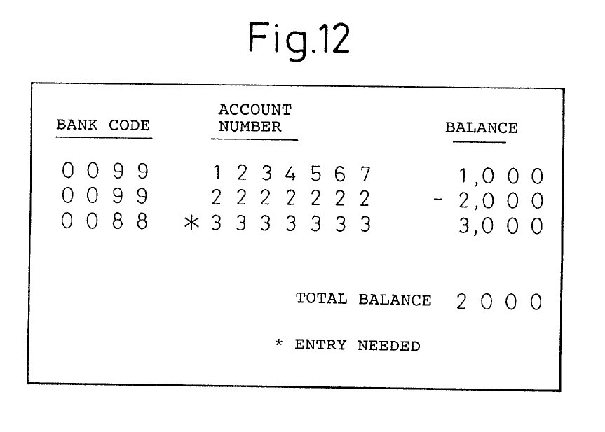

With no insertion of card or bankbook at step S15, the account balance data drawing section 12 draws the balance from each bank account (S18), wherein the account balance data drawing section 12 drawing the balance from other bank's host computer upon finding of other bank's account, while drawing the balance from its own bank's host computer upon finding of no more account of other bank. Then the print out compilation section 24 compiles the print out data (S19), and the print out section 25 prints out the receipt and ejects it (S20). A voice guidance follows, saying “Please, check your receipt.” (S21). An example of a printed out receipt is shown in FIG. 12.

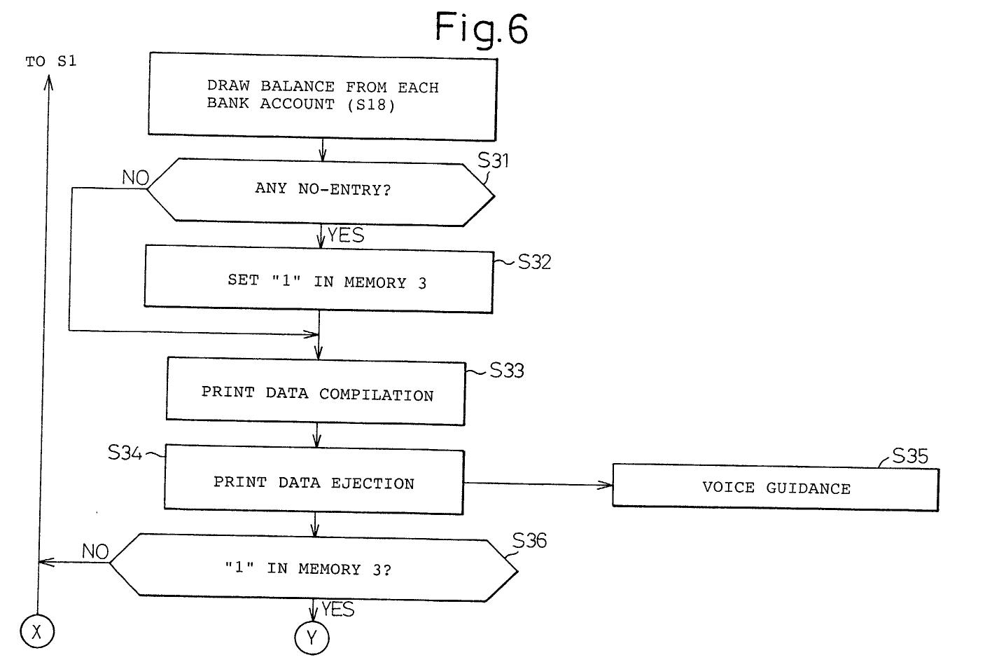

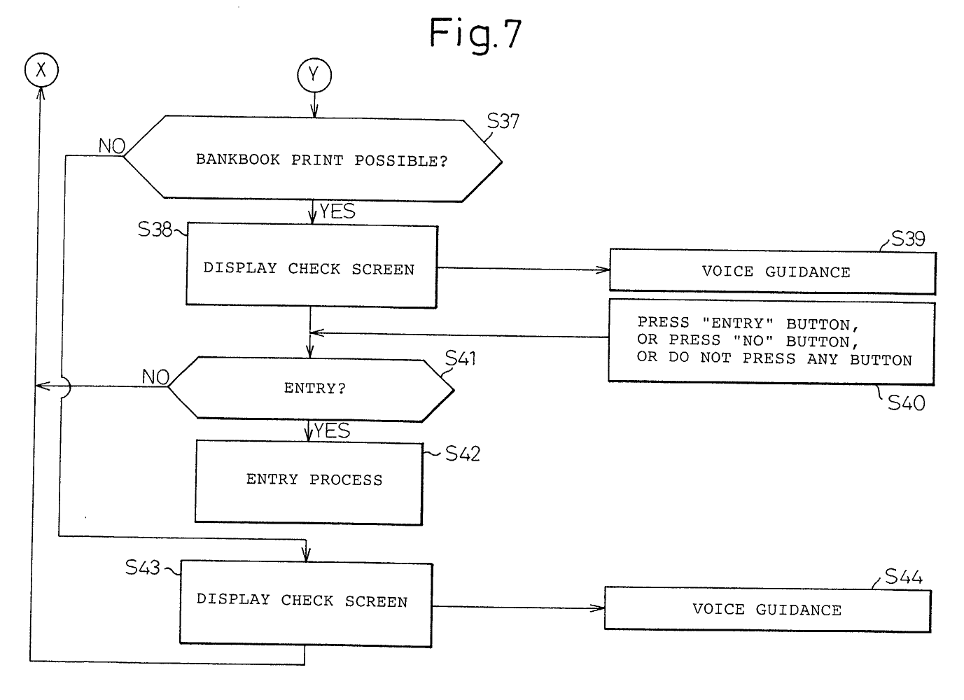

FIG. 6 and FIG. 7 are flow charts showing processes performed upon finding of a non-entry in the bankbook during the course of processes represented in FIG. 4 and FIG. 5. At the process indicated at S18 shown in FIG. 5, the customer's account can be guided to the no-entry process, after the balance drawing from each bank account, without proceeding to the print out data compilation (reference at S19). This particular process is aimed for improvement of customer service.

After the balance in each bank account is drawn at step S18, the no-entry detection section 14 determines the existence or non-existence of the no-entry (S31), and, upon finding of no-entry (YES), sets “1” in the memory 3 (S32). The print out data compilation section 24 compiles the print out data (S33), and the print out section 25 prints out the receipt and ejects it out (S34). Then a voice guidance follows, saying “Please, check your receipt” (S35). The example of the receipt is shown in FIG. 12. Also, upon non-existence of the no-entry at step S31 (NO), the print out compilation section 24 compiles the print out data. The print out compilation section then determines whether the contents of the memory 3 is “1” or not (S36), where “1” produces (YES) answer to be followed by determination on whether the print out in the bankbook is possible or not (S37).

As indicated in FIG. 7, (YES) answer is produced if the print out is possible at step S37, which leads to a display of “check screen” on the display section 21 (S38). A vocal guidance follows, saying “You have a no-entered account. Would you like to make an entry? ” (S39). Following to the guidance, the customer makes his or her decision to press the “entry” button, or “no” button, or not to press the button (no press) (S40). According to customer's decision, “entry” or not is determined (S41), where “entry” produces a (YES) answer for subsequent execution of the entry process (S42).

Meanwhile, no printing out in the bankbook at step S37 (NO) results in a display of “check screen” (S43). The voice guidance follows, saying “You have a no-entry account. Please, make an entry at your earliest convenience.” (S44).

When “1” is not set at step S36 (NO), or no-entry at S41 (NO), operational status returns to S1, standing by for next customer. Display of “check screen” at step S43 also results in the returning to step S1.

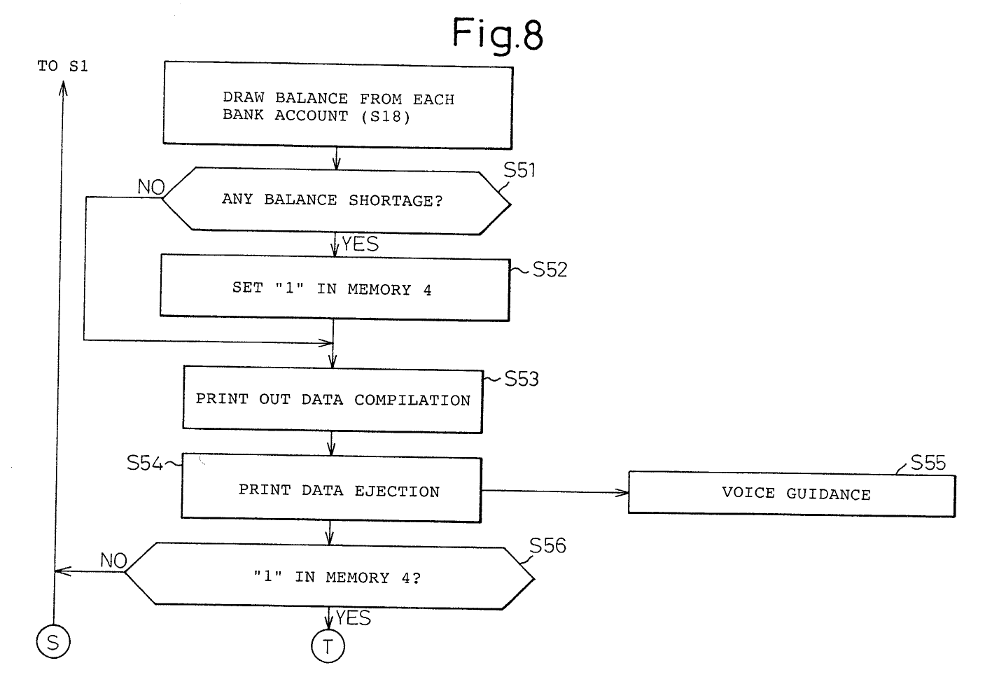

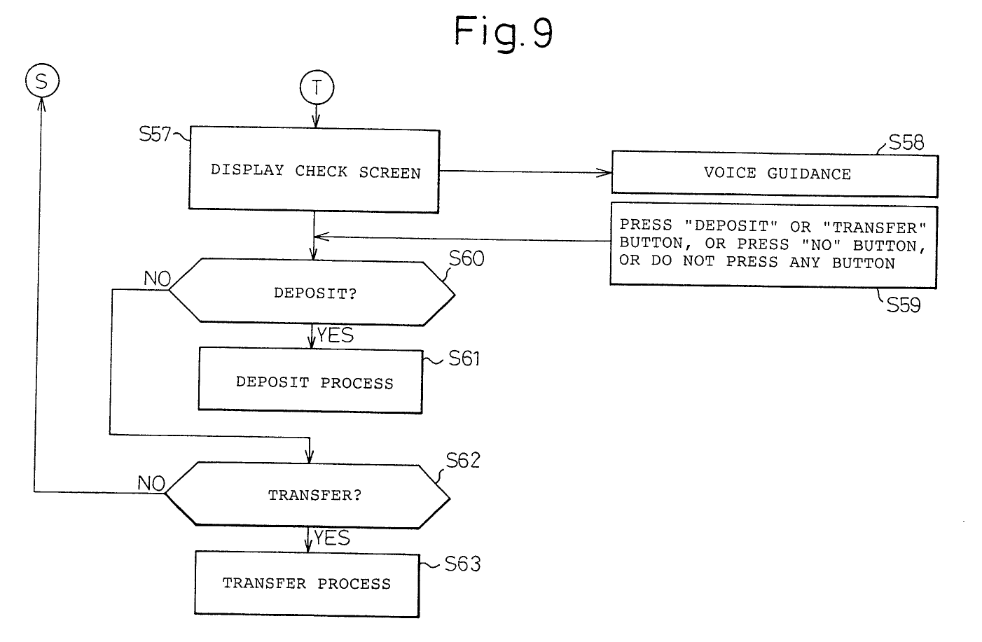

FIG. 8 and FIG. 9 are the flow charts showing the processes performed upon finding of the minus balance during the course of processes represented in FIG. 4 and FIG. 5. In the process at step S18 shown FIG. 5, customer's account can be guided, after the balance drawing from each bank account, to the deposit/transfer process without proceeding to the print out data compilation, as an improved customer service.

After the balance in each bank account is drawn at step S18, the minus balance detection section 13 determines the existence or non-existence of the balance shortage (S51), producing (YES) answer upon finding a balance shortage, and sets “1” in the memory 4 (S52). Then the print out data compilation section 24 compiles the print out data (S53), and the print out section 25 prints out the receipt and ejects it out (S54). The voice guidance follows, saying “Please, check your receipt.” (S55). An example of the receipt is shown in FIG. 12. Also, upon not finding a balance shortage at step S51 (NO), step S53 follows to print out the data. Then, whether the contents of the memory 4 is “1” or not is determined (S56).

Subsequently, as shown in FIG. 9, “1” at step S56 produces (YES) answer, which is followed by display of the “check screen”. Then the vocal guidance comes up, saying “You have a balance shortage in your account. Would you like to make deposit or transfer? ” (S58). According to his or her decision on the voice guidance, the customer makes the next move, which is pressing of “deposit” button, or “transfer” button, or “no” button, or not pressing any button (S59). Then whether “deposit” or not is determined (S60), and “deposit” (YES) leads to the deposit process (S61).

Meanwhile, a no deposit result at step S60 (NO) is followed by a determination on transfer or no transfer (S62). The result for transfer (YES) leads to the transfer process (S62). Also, in each case, where no setting of “1” in the memory 4 at step S56 (NO) and no transfer at step S62 (NO), the operational status returns to step S1 in FIG. 4, to wait for another customer.

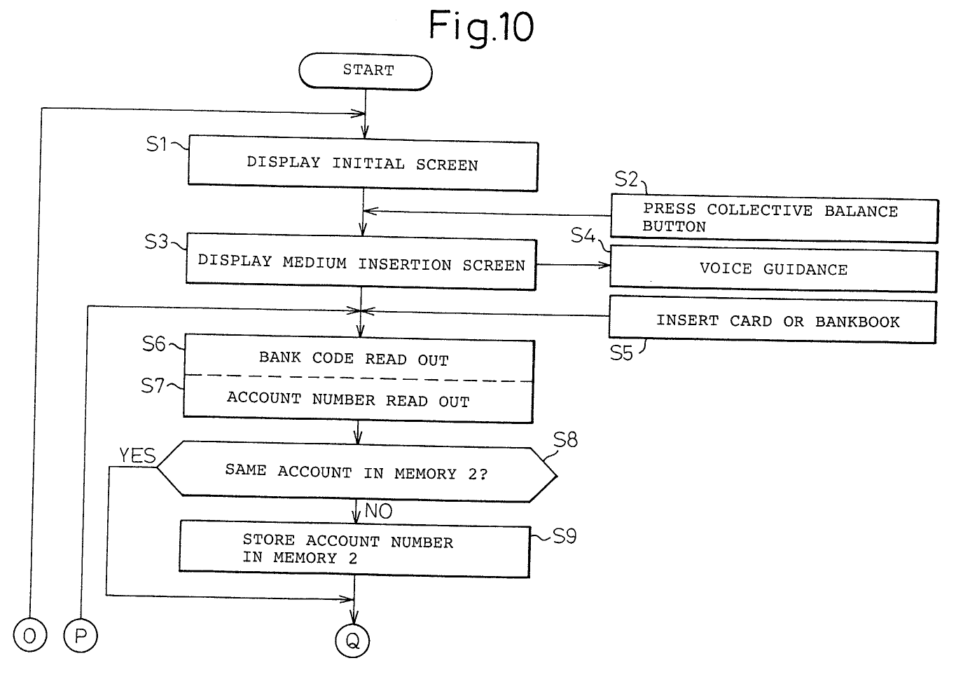

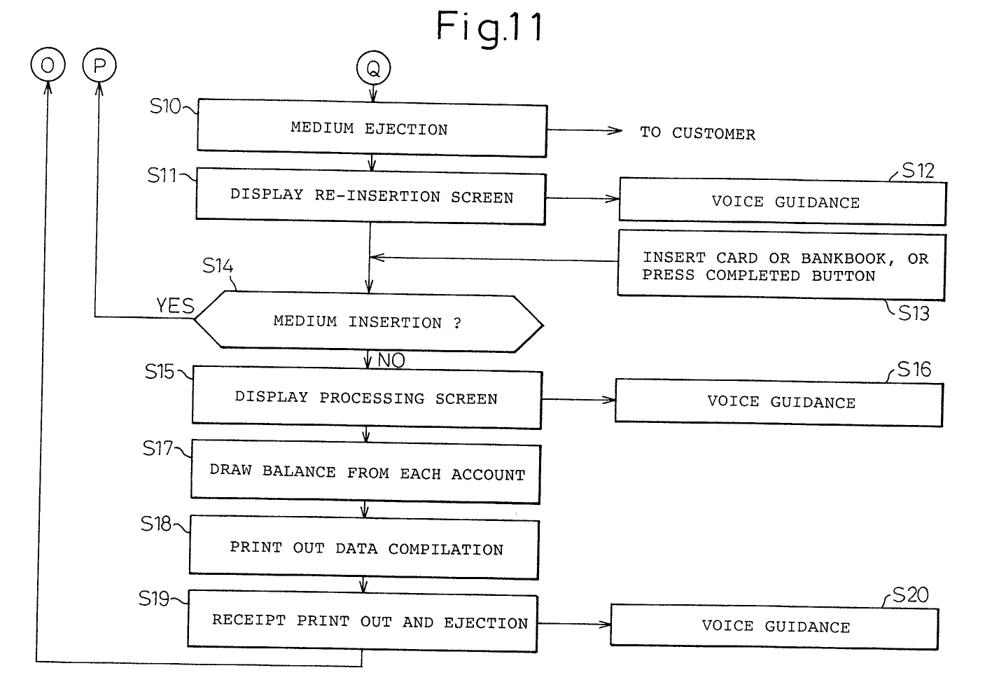

FIG. 10 and FIG. 11 are the flow charts showing the processes of another example, performed in the collective balance calculation automatic process system shown in FIG. 1. The example represented in the above flow charts is a case in which the memory 1 storing a plurality of bank codes is eliminated. In this example, accesses from other banks' host computers to this system have no limitation. Therefore, as indicated in the Figures, the process shown at step S8 in FIG. 4, which is “whether the bank code is in the memory of the first storage mean 1 or not” becomes unnecessary. Other steps performed in this example are the same ones shown in FIG. 4 and FIG. 5, which means that the each step (S8 to S20) in FIG. 10 and FIG. 11 correspond to each step (S9 to S21) in FIG. 4 and FIG. 5. Therefore, more a specific explanation is omitted.

FIG. 12 is a view of the receipt printed out and ejected, out for customer, from ATM in the processes represented in FIG. 4 to FIG. 11. In the Figure, “-” symbol attached to a bank code “0099” represents the minus balance , and “*” symbol attached to a bank code “0088” represents an entry instruction to an account specified by account number “3333333”.

Industrial Application Field

As mentioned before, a conventional system has an inconvenience that requires customers to register their accounts in their own banks beforehand, wherein only the pre-registered accounts are checked all together and the accounts not pre-registered cannot be checked. According to this invention, customers can perform, without the account being pre-registered, the collective balance calculation on each desired account with an easy operation, which is achieved by software replacements by utilizing conventional hardware, resulting in a low system construction cost. Thus, customers can easily perform various transactions at various places, using a card or a bankbook, by their own manual operation, the transactions including automatic deposit and drawing. This invention has a great potential for application in the industrial field.

1. A collective balance calculation automatic process system, related to an automatic transaction system, consisting of a host computer and a plurality of ATMs, which automatically processes customer's deposit and drawing, comprising:
an account data accumulation section for collecting and totally storing balance data in each of a customer's accounts;
an account balance data drawing section for drawing the balance in each customer account from said account data accumulation section and collectively calculating them;
first storage means for storing one or a plurality of bank codes;
second storage means for storing one or plurality of account numbers; and
a medium data read out section for reading out the customer data recorded in a customer's medium and transmitting them to said account balance data drawing section;
wherein; said medium data read out section reads out a bank code and a account number from said medium, the read out bank code is recorded in said first storage means, and the read out account number is recorded in said second storage means, or is recorded in said second storage means if no record is found and said medium is returned to a customer temporarily;
wherein said medium data read out section performs the same process described above on other mediums inserted by the customer, producing a determination of insertion being completed by having no insertion of other mediums by the customer,
wherein said account balance data drawing section draws and collectively calculates the balance corresponding to the read out accounting number specified by each read out bank code, by referring to said account data accumulation section.

2. The collective balance calculation automatic process system, related to the automatic transaction system consisting of the host computer and a plurality of ATMs, which automatically processes customer's deposit and drawing, comprising:
an account data accumulation section for collecting and totally storing the balance data in each customer account;
an account balance data drawing section for drawing the balance in each customer account from said account data accumulation section and collectively calculating them;
a storing means for storing one or a plurality of account numbers; and
a medium data read out section for reading out the customer account recorded in customer's medium and transmitting them to said account balance data drawing section;
wherein; said medium data read out section reads out the account number from said medium, the read out account number is recorded in said storing means, or in a case of no recording, the account number is recorded and the medium is returned to the customer temporarily;
wherein said medium data read out section performs the same process on other mediums inserted by the customer, producing a determination of insertion being completed by having no insertion by the customer; and
wherein said account balance data drawing section draws and collectively calculates the balance in the account corresponding to the read out account number specified by the read out account number, by referring to said data accumulation section.

3. The collective balance calculation automatic process system claimed in claim 1 further comprises a third storage means for storing the existence or the non-existence of a no-entry, and a no-entry detection section for detecting the no-entry in each customer account; wherein, said no-entry detection section setting a flag in said third storage means upon finding no-entry, after having drawn the balance corresponding to read out account specified by the read out bank code, and compiling print out data and printing it out.

4. The collective balance calculation automatic process system claimed in claim 2 further comprises a third storage means for storing the existence or the non-existence of a no-entry, and a no-entry detection section for detecting the no-entry in each customer account; wherein, said no-entry detection section setting a flag in said third storage means upon finding no-entry, after having drawn the balance corresponding to read out account specified by the read out bank code, and compiling print out data and printing it out.

5. The collective balance calculation automatic process system claimed in claim 1 further comprises a fourth storing means for storing the existence or non-existence of the minus balance, and a minus balance detection section for detecting the existence or non-existence of the minus balance; wherein, said minus balance detection section setting the flag in said fourth storing means upon finding the minus balance, after having drawn the balance corresponding to the read out account number specified by each read out bank code, and compiling the print out data and printing it out.

6. The collective balance calculation automatic process system claimed in claim 2 further comprises a fourth storing means for storing the existence or non-existence of the minus balance, and a minus balance detection section for detecting the existence or non-existence of the minus balance; wherein, said minus balance detection section setting the flag in said fourth storing means upon finding the minus balance, after having drawn the balance corresponding to the read out account number specified by each read out bank code, and compiling the print out data and printing it out.
